(19) United States
(12) Patent Application Publication
(10) Pub. No.: US 2024/0242421 A1
(43) Pub. Date: Jul. 18, 2024

(54) POSITIONING CAMERA IN METAVERSE

(71) Applicant: INTERNATIONAL BUSINESS MACHINES CORPORATION, ARMONK, NY (US)

(72) Inventors: Ye Chuan Wang, Beijing (CN); Ju Ling Liu, Beijing (CN); Nan Chen, Beijing (CN); June-Ray Lin, Taipei City (TW); Li Na Wang, Beijing (CN)

(21) Appl. No.: 18/155,782

(22) Filed: Jan. 18, 2023

(51) Int. Cl. G06T 15/20; G06T 7/60; G06T 7/70

(52) U.S. Cl. CPC G06T 15/20; G06T 7/60; G06T 7/70; G06T 2207/30196; G06T 2207/30244; G06T 2210/21

(57) ABSTRACT

Embodiments of present invention provide a method of taking photo in a virtual reality environment. The method includes defining a group that includes multiple entities; detecting multiple directions that the multiple entities are facing based upon orientations of the multiple entities; identifying multiple extension lines that start from the multiple entities in the group and extend in the multiple directions; identifying one or more intersections associated with the multiple directions; identifying one or more connection lines that connect a center of the group to the one or more intersections; defining a camera line based on the one or more connection lines; determining a camera location along the camera line; taking an image of virtual view of the multiple entities by a virtual camera; and providing the image as a photo to the multiple entities in the group. A non-transitory storage medium and a computing environment are also provided.

### BACKGROUND

The present application relates generally to the field of computing in virtual reality applications, and more particularly to a method of positioning virtual camera in taking photos in a metaverse world.

With the rise in popularity since the introduction of concept of the metaverse, social events like meetings, parties, and dances, for example, have been rapidly introduced into the metaverse and setting a trend that most people particularly young generations will soon, if not already, find it irresistible to follow and participate. Just like in a real world where people would capture exciting and unforgettable moments using digital camera such as, for example, using those that come with the iPhone, during live events in the metaverse or in a virtual reality environment, event participants have long felt the need or desire and consider it essential that they be able to capture and share important moments using a virtual camera. In the real world, physical digital cameras may be set to an auto-mode or on a timer that will then automatically take pictures whenever the camera picks up, for example, most smiles. However, unlike in the real-world where people take it for granted, in the virtual reality environment or the metaverse world, currently there is no readily available solution that offers a photo taking functionality by a virtual camera.

### SUMMARY

Embodiments of present invention provide a method of taking photo in a virtual reality environment. The method includes defining a group that includes multiple entities; detecting multiple directions that the multiple entities are facing based upon orientations of the multiple entities; identifying multiple extension lines that start from the multiple entities in the group and extend in the multiple directions; identifying one or more intersections associated with the multiple directions identifying one or more connection lines that connect a center of the group to the one or more intersections; defining a camera line based on the one or more connection lines; determining a camera location along the camera line; taking an image of virtual view of the multiple entities by a virtual camera; and meeting the desire of taking photo by the multiple entities by providing the image as a photo to the multiple entities in the group.

In one embodiment, defining the group includes identifying the multiple entities from a cluster of entities based on a size of the group and distances among the entities in the cluster.

In another embodiment, identifying the one or more intersections includes identifying the one or more intersections made by the multiple extension lines.

In yet another embodiment, identifying the one or more connection lines further includes identifying the center of the group as a center of a circle that circles the group, wherein at least three entities in the group are along a perimeter of the circle.

In one embodiment, defining the camera line includes, if there is only one connection line, defining the camera line as along the connection line; or if there are two connection lines, defining the camera line as along a line that bisects an ordinary angle formed by the two connection lines; or if there are more than two connection lines, defining the camera line as along a line that bisects an ordinary angle formed by two connection lines that pass through first two intersections made by majority of the multiple extension lines.

In another embodiment, defining the camera line includes, if there is only one connection line, defining the camera line as along the connection line; or if there are two connection lines, defining the camera line as along a line that bisects an ordinary angle formed by the two connection lines; or if there are more than two connection lines and there is a reflex angle formed by two adjacent connection lines, defining the camera line as along a line that bisects an explementary angle of the reflex angle formed by the two adjacent connection lines.

In yet another embodiment, defining the camera line further includes, if there are more than two connection lines and there is no reflex angle between any two adjacent connection lines, identifying a base connection line that passes through an intersection made by majority of the multiple extension lines; identifying a removable connection line that forms a largest ordinary angle with the base connection line; and removing the removable connection line.

In one embodiment, determining the camera location along the camera line includes deciding a focal length f of the virtual camera; deciding a distance v of the image of virtual view from the virtual camera; and determining the camera position along the camera line at a location u measured from the center of the group by an equation of

$$\frac{1}{u} + \frac{1}{v} = \frac{1}{f} .$$

Embodiments of present invention also provide a non-transitory storage medium thereupon stored a set of computer-readable instructions that, when being executed by a computer, cause the computer to perform defining a group that includes multiple entities; detecting multiple directions that the multiple entities are facing based upon orientations of the multiple entities; identifying multiple extension lines that start from the multiple entities in the group and extend in the multiple directions; identifying one or more intersections associated with the multiple directions; identifying one or more connection lines that connect a center of the group to the one or more intersections; defining a camera line based on the one or more connection lines; determining a camera location along the camera line; taking an image of virtual view of the multiple entities by a virtual camera; and meeting the desire of taking photo by the multiple entities by providing the image as a photo to the multiple entities in the group.

Embodiments of present invention further provide a computing environment that includes a processor set; a communication fabric; at least one volatile memory; a persistent storage; and a set of peripheral devices, wherein the persistent storage further includes an operating system and stores thereupon a metaverse application program, the metaverse application program, when being executed by the computing environment, causes the computing environment to perform defining a group that includes multiple entities; detecting multiple directions that the multiple entities are facing based upon orientations of the multiple entities; identifying multiple extension lines that start from the multiple entities in the group and extend in the multiple directions; identifying one or more intersections associated with the multiple directions; identifying one or more connection lines that connect a center of the group to the one or more intersections; defining a camera line based on the one or more connection lines; determining a camera location along the camera line; taking an image of virtual view of the multiple entities by a virtual camera; and meeting the desire of taking photo by the multiple entities by providing the image as a photo to the multiple entities in the group.

### BRIEF DESCRIPTION OF THE DRAWINGS

The present invention will be understood and appreciated more fully from the following detailed description of embodiments of present invention, taken in conjunction with accompanying drawings of which:

FIG. 1 is a demonstrative illustration of a networked computer environment according to one embodiment of present invention;

FIG. 2 is an operational diagram of a metaverse application in positioning virtual camera and taking photo of a group of entities according to one embodiment of present invention;

FIG. 3 is an operational flow-chart of a metaverse application in positioning virtual camera and taking photo of a group of entities in a virtual reality environment according to one embodiment of present invention;

FIG. 4 is a demonstrative illustration of a method of defining a group of entities for taking photo in a virtual event according to one embodiment of present invention;

FIG. 5 is a demonstrative illustration of a method of defining a camera line for taking photo of a group of entities according to one embodiment of present invention;

FIG. 6 is a demonstrative illustration of a method of defining a camera line for taking photos of a group of entities according to another embodiment of present invention;

FIG. 7 is a demonstrative illustration of a method of defining a camera line for taking photos of a group of entities according to yet another embodiment of present invention;

FIG. 8 is a demonstrative illustration of a method of defining a camera line for taking photos of a group of entities according to a further embodiment of present invention;

FIGS. 9A, 9B, and 9C are demonstrative illustrations of a method of defining a camera line for taking photos of a group of entities according to one embodiment of present invention; and

FIG. 10 is a demonstrative illustration of a method of deciding a camera location on a camera line according to one embodiment of present invention.

It will be appreciated that for simplicity and clarity purpose, elements shown in the drawings have not necessarily been drawn to scale. Further, and if applicable, in various functional block diagrams, two connected devices and/or elements may not necessarily be illustrated as being connected. In some other instances, grouping of certain elements in a functional block diagram may be solely for the purpose of description and may not necessarily imply that they are in a single physical entity, or they are embodied in a single physical entity.

### DETAILED DESCRIPTION

In the below detailed description and the accompanying drawings, various embodiments of structures and/or methods of present invention may be disclosed. However, it shall be understood that the present invention may be embodied in various other and/or different forms and thus shall not be construed as being limited to the particular illustrative embodiments demonstratively shown here. In the description, details of some well-known features and techniques may be omitted in order to avoid unnecessarily obscuring the disclosed embodiments.

It is to be understood that the singular forms of “a,” “an,” and “the” may include plural referents unless the context clearly dictates otherwise. For example, reference to “a component surface” may include reference to one or more of such surfaces unless the context clearly dictates otherwise.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

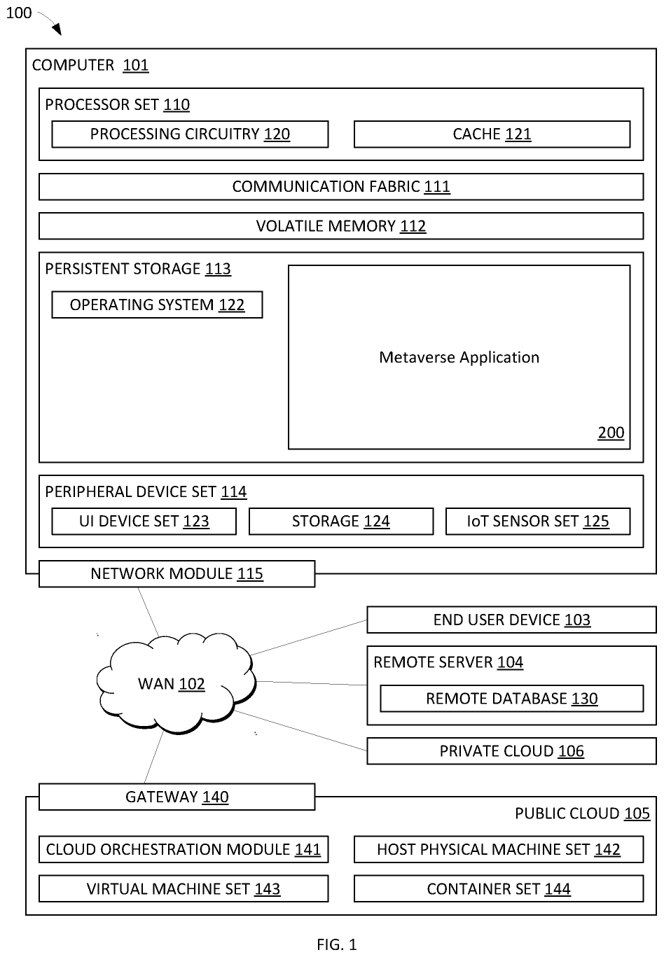

FIG. 1 is a demonstrative illustration of a networked computer environment according to one embodiment of present invention. Computing environment 100 contains an example of an environment for the execution of at least some of the computer code involved in performing the inventive methods, such as a metaverse application 200, also referred to here as a block 200, that processes and handles the display of a virtual pointer in a virtual display such as, for example, a virtual keyboard, a set of virtual menu items, or a virtual interactive picture. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

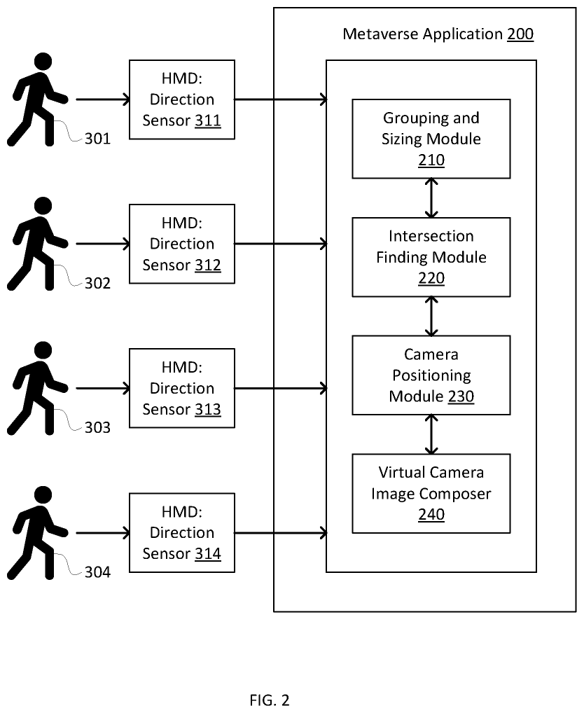

FIG. 2 is an operational diagram of a metaverse application in positioning virtual camera and taking photo of a group of entities according to one embodiment of present invention. More particularly, embodiments of present invention provide taking photo of a cluster of entities, which are generally human beings but may possibly include non-human entities such as, for example, dogs as well. The cluster of entities may be carrying such as wearing direction sensing devices and participating in a social event. For example, entities 301, 302, 303, and 304 may be carrying or wearing direction sensors 311, 312, 313, and 314 respectively, and the direction sensors 311, 312, 313, and 314 may be interacting with a metaverse application 200. Further for example, the direction sensors 311, 312, 313, and 314 may be providing real time information such as orientations of or directions that the entities 301, 302, 303, and 304 are individually facing to the metaverse application 200. In one embodiment, the direction sensors 311, 312, 313, and 314 may be part of a head-mounted display (HMD) that the entities 301, 302, 303, and 304 are carrying or wearing. In general, the cluster of entities may be a large group of entities involving tens to hundreds of entities. However, embodiments of present invention are not limited by the size of the cluster and may be applied to any size of clusters.

At a high level, the metaverse application 200 may include a grouping and sizing module 210, an intersection finding module 220, a camera positioning module 230, and a virtual camera image composer 240, all of which may work together to provide virtual camera positioning and photo rendering experience. More particularly, the grouping and sizing module 210 may group or divide the cluster of entities who are attending the virtual event into multiple groups based on a set of criteria. In other words, the grouping and sizing module 210 may be able to define a group of entities, from the cluster of entities, such that a virtual camera may be able to find a position to simulate taking photo of the group that includes a number of entities. In deciding the position of the virtual camera, the intersection finding module 220 may first generate multiple extension lines, from the number of entities in the group, in directions that the entities are facing; identify one or more intersections made by the multiple extension lines; and identify one or more connection lines from a center of the group to the one or more intersections. Next, the camera positioning module 230 may define a camera line based on the one or more connection lines and decide a location of the virtual camera along the camera line. Finally, the virtual camera image composer 240 may use an image of virtual view from the virtual camera to simulate taking photo and subsequently render the image as a photo to the number of entities in the group. Embodiments of present invention may provide taking photo for each of the groups divided from the cluster of entities.

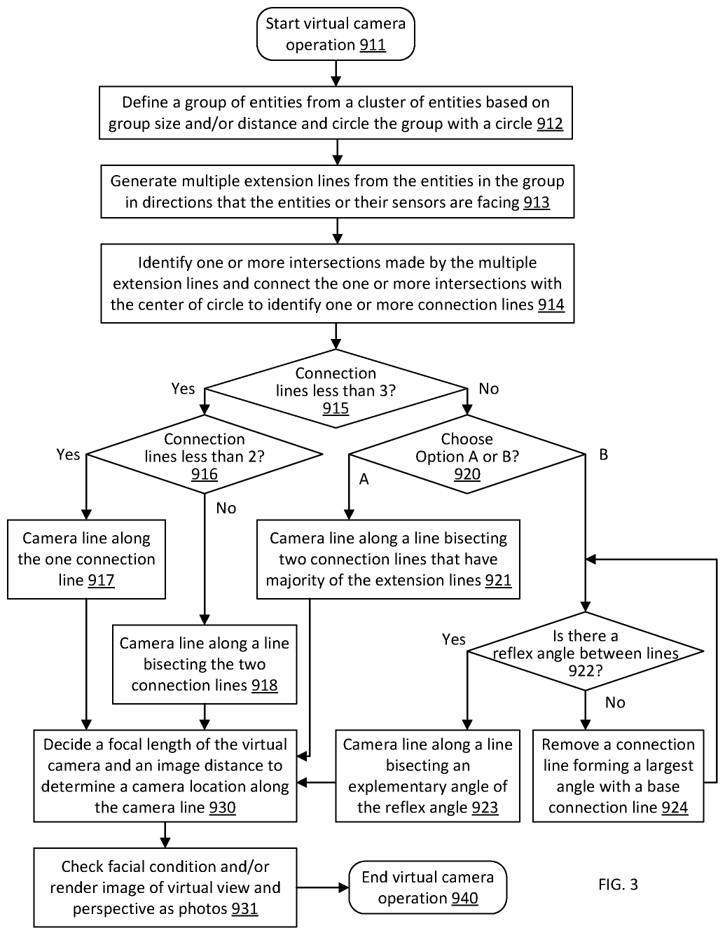

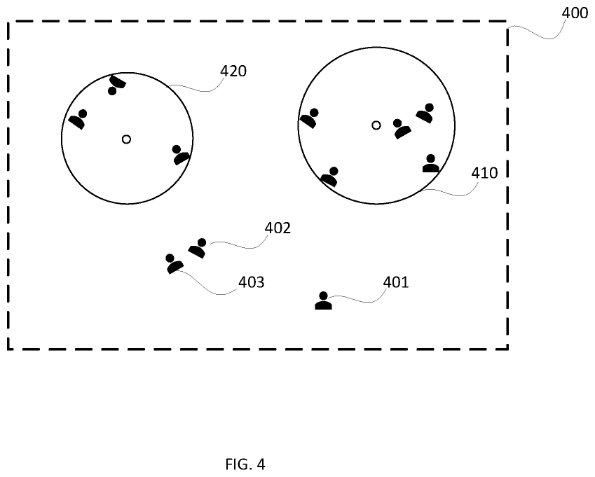

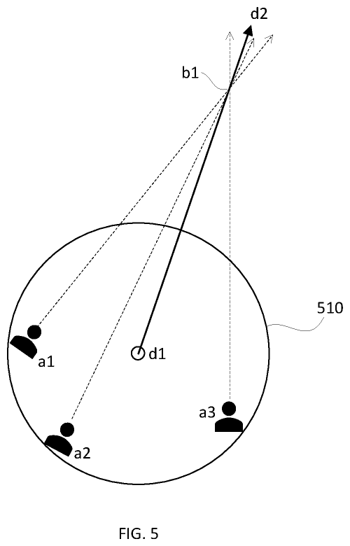

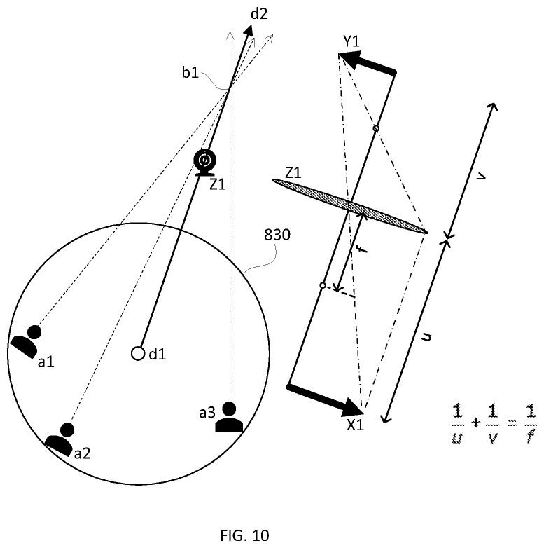

In the below detailed description, embodiments of present invention may be described using a simplified operational flow-chart, as is demonstratively illustrated in FIG. 3, of the metaverse application 200 in positioning a virtual camera in a metaverse world or virtual reality environment. The description may be made in conjunction with FIG. 4, which demonstratively illustrates how a cluster of entities may be divided into a number of groups, i.e., how a group of entities may be defined from the cluster of entities, in conjunction with FIGS. 5, 6, 7, 8, and 9A-9C, which demonstratively illustrates various embodiments in defining a camera line for the virtual camera, and in conjunction with FIG. 10, which demonstratively illustrates how a camera location may be decided along the camera line for the virtual camera.

FIG. 3 is an operational flow-chart of a metaverse application 200 in positioning virtual camera and taking photo in a metaverse world or virtual reality environment according to one embodiment of present invention. More particularly, embodiments of present invention provide starting the virtual camera operation (step 911) by defining a group of entities from a cluster of entities who may be participating in a virtual live event, based upon a set of criteria such as, for example, a pre-determined size of the group and/or distances among the entities in the group, and circling the group with a virtual circle (step 912). In deciding the virtual circle, in one embodiment, at least three entities in the group may be found to be along the perimeter of the virtual circle.

Reference is briefly made to FIG. 4, which is a demonstrative illustration of a method of defining a group of entities for taking photo in a virtual event according to one embodiment of present invention. More particularly, embodiments of present invention provide dividing a cluster 400 of entities into multiple groups such as, for example, a group 410 and a group 420. Defining the group 410 and/or the group 420 may be made based upon a number of criteria such as, for example, total number of entities in the cluster 400, distances among the entities, size of the groups 410 and 420, total number of groups in relation to total number of entities in the cluster 400, etc. Sometimes, some entities such as entity 401, entity 402, and entity 403 may be better left alone to not belong to any groups and their photos may be taken separately.

A virtual camera position may then be made for each group of entities. The camera position may include a location of the virtual camera on a camera line. The camera line may be defined, as is described below in more details, for various embodiments.

Reference is now made back to FIG. 3, where embodiments of present invention further provide generating multiple extension lines from the number of entities in the group and in directions that the entities or direction sensors, such as headset, that the entities carry or wear are facing (step 913); and identifying one or more intersections made by the multiple extension lines and connecting the one or more intersections with the center of the virtual circle that circles the group to identify one or more connection lines (step 914).

Next, embodiments of present invention provide checking or confirming whether the number of connection lines is equal to 1, 2, or 3 and more. For example, in one embodiment, the metaverse application 200 may check whether the number of connection lines is less than 3 (step 915) and, if the answer is “YES”, continue to check whether the number of connection lines is less than 2 (step 916). If the answer is still “YES”, in other words if there is only one connection line, embodiments of present invention then provide defining a camera line to be along the one connection line (step 917).

As is demonstratively illustrated in FIG. 5, in this embodiment, multiple extension lines made from the group of entities a1, a2, and a3 make a single intersection b1. Hereinafter, it is to be noted that when referring to several extension lines making an intersection, it means that the several extension lines pass through at least a vicinity of the intersection, and it does not necessarily mean that the several extension lines have to pass exactly through the intersection. In this case, a single connection line d1-b1 is made from the center d1 of the circle 510 and through the single intersection b1, pointing at the direction d2. Embodiments of present invention then provide defining that the camera line be along the connection line d1-b1.

Back to the step 916, with regard to the question whether the number of connection lines is less than 2, if the answer is “NO”, in other words there are two connection lines, embodiments of present invention then provide defining a camera line to be along a line that bisects an ordinary angle formed by the two connection lines (step 918). Here, an ordinary angle means an angle formed by two connection lines that is less than 180 degrees.

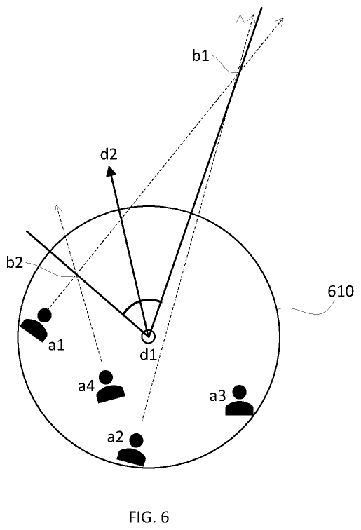

As is demonstratively illustrated in FIG. 6, in this embodiment, extension lines made from the group of entities a1, a2, a3, and a4 make two intersections b1 and b2, therefore two connection lines d1-b1 and d1-b2 may be made from the center d1 of the circle 610 and through the two intersections b1 and b2 respectively. Embodiments of present invention then provide defining the camera line to be along a line d1-d2 that bisects the ordinary angle formed by the two connection lines d1-b1 and d1-b2. In other words, the camera line d1-d2 bisects the angle that is smaller than 180 degrees formed by the two connection lines d1-b1 and d1-b2.

Back to the step 915, with regard to the question whether the number of connection lines is less than 3, if the answer is “NO”, in other words there are three or more connection lines, embodiments of present invention then provide two options A or B (step 920) for defining a camera line. If the answer to choosing options is “A”, embodiments of present invention then provide defining the camera line to be along a line that bisects an ordinary angle formed by two connection lines that pass through the first two intersections that are made by majority of the multiple extension lines (step 921).

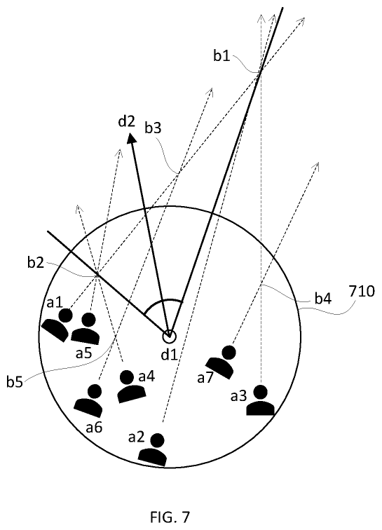

As is demonstratively illustrated in FIG. 7, in this embodiment, extension lines made from the group of entities a1, a2, a3, a4, a5, a6, and a7 make multiple intersections including, for example, b1, b2, b3, b4, and b5. Among the multiple intersections, both intersections b1 and b2 have three extension lines going through thereof, making them the two intersections that have majority of the extension lines. Embodiments of present invention then provide connecting the center of the circle 710 with the two intersections b1 and b2 to make two connection lines d1-b1 and d1-b2 respectively; and defining the camera line to be along a line d1-d2 that bisects the ordinary angle formed by the two connection lines d1-b1 and d1-b2. More specifically, the camera line d1-d2 bisects the angle that is smaller than 180 degrees formed by the two connection lines d1-b1 and d1-b2.

Back to the step 920, if the answer to choosing options is “B”, embodiments of present invention then provide checking whether there is an reflex angle, i.e., an angle that is larger than 180 degrees, between two neighboring or adjacent connection lines (step 922), and if the answer is “YES”, then defining the camera line to be along a line that bisects an explementary angle of this reflex angle formed by the two neighboring or adjacent connection lines (step 923).

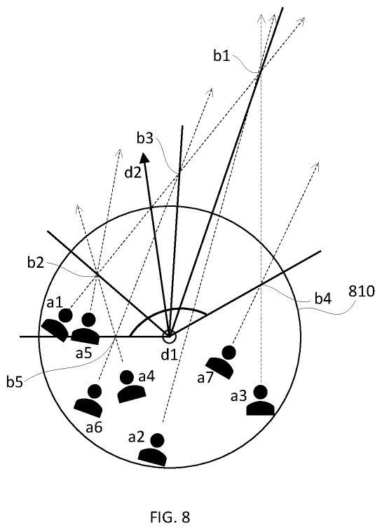

As is demonstratively illustrated in FIG. 8, in this embodiment, extension lines made from the group of entities a1, a2, a3, a4, a5, a6, and a7 make multiple intersections including, for example, b1, b2, b3, b4, and b5. Embodiments of present invention then provide connecting the center of the circle 810 with the intersections b1, b2, b3, b4, and b5 to make connection lines d1-b1, d1-b2, d1-b3, d1-b4, and d1-b5. Since the angle formed by the two neighboring connection lines d1-b4 and d1-b5 satisfies the condition of being a reflex angle of larger than 180 degrees, embodiments of present invention provide defining the camera line to be along a line d1-d2 that bisects an explementary angle of this reflex angle of larger than 180 degrees and formed by the two neighboring or adjacent connection lines d1-b4 and d1-b5.

Back to the step 922, with regard to the question whether there is a reflex angle of larger than 180 degrees between any two neighboring or adjacent connection lines, if the answer is “NO”, then embodiments of present invention provide identifying a removable connection line that forms two angles with two neighboring or adjacent connection lines with a sum of the two angles being a largest among sums of any two neighboring or adjacent angles; removing this removable connection line; and returning back to the step 922 (step 924).

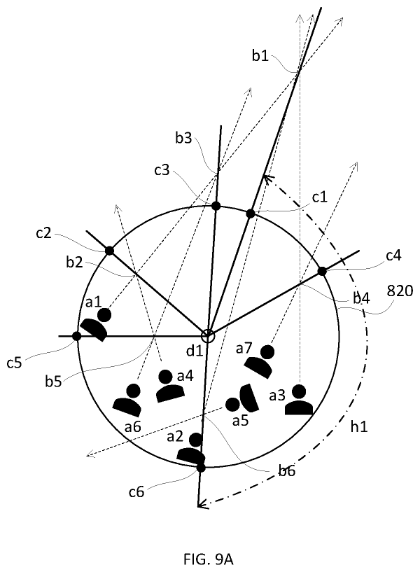

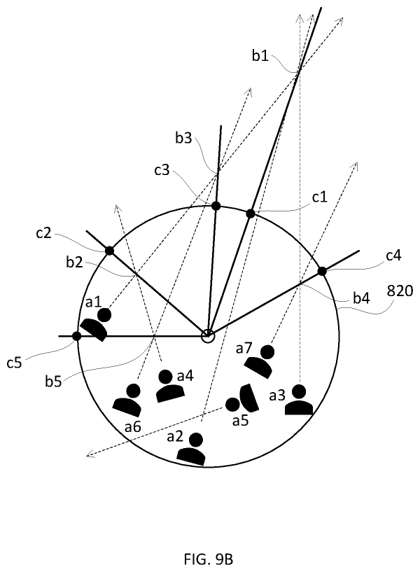

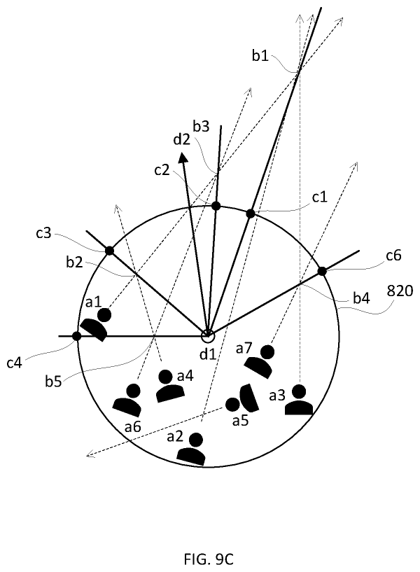

As is demonstratively illustrated in FIG. 9A, in this embodiment, extension lines made from the group of entities a1, a2, a3, a4, a5, a6, and a7 make multiple intersections including, for example, b1, b2, b3, b4, b5, and b6. Embodiments of present invention then provide connecting the center d1 of the circle 820 with the intersections b1, b2, b3, b4, b5, and b6 to make connection lines d1-b1, d1-b2, d1-b3, d1-b4, d1-b5, and d1-b6. In the meantime, the connection lines d1-b1, d1-b2, d1-b3, d1-b4, d1-b5, and d1-b6 make an intersections c1, c2, c3, c4, c5, and c6 respectively with the circle 820. In the demonstratively illustrated example, there is no reflex angle between any two neighboring or adjacent connection lines. Embodiments of present invention provide identifying the connection line d1-b1 as a base connection line that passes through the intersection b1 made by most of the extension lines or majority of the extension lines; identifying the connection line d1-b6, among all the connection lines, as a removable connection line that forms the largest ordinary angle h1 with the base connection line d1-b1; and removing the removable connection line d1-b6, as is demonstratively illustrated in FIG. 9B.

To describe in a different way, when there is no arc along the circle 820 that is more than half of the circle 820, embodiments of present invention provide identifying a base connection line, such as the connection line d1-b1, that passes through an intersection, such as the intersection b1, with the most extension lines or majority of the extension lines. Embodiments of present invention further provide identifying a removable connection line, such as the connection line d1-b6, where a minor arc formed by the removable connection line d1-b6 and the base connection line d1-b1, such as the arc from c6 to c1, has the longest length, among all other connection lines and the base connection line d1-b1. Upon identifying the base connection line d1-b1 and the removable connection line d1-b6, embodiments of present invention provide removing the removable connection line d1-b6 and the intersection c6.

As is demonstratively illustrated in FIG. 9C, the intersection c6 and the connection line d1-b6 are removed. Embodiments of present invention provide going back to step 922 and checking again whether there is a reflex angle of larger than 180 degrees between two neighboring or adjacent connection lines. Because the angle formed by the two neighboring connection lines d1-b4 and d1-b5 now satisfies the condition of being a reflex angle, that it, larger than 180 degrees, embodiments of present invention provide defining the camera line to be along a line d1-d2 that bisects an explementary angle of the reflex angle formed by the two neighboring connection lines d1-b4 and d1-b5.

After the camera line d1-d2 is determined, whether it is decided at step 917, step 918, step 921, or at step 923 as illustrated in FIG. 3, embodiments of present invention provide determining a location of the virtual camera along the camera line d1-d2. More particularly, embodiments of present invention provide deciding a focal length of the virtual camera and an image distance to determine a camera location along the camera line (step 930). As is demonstratively illustrated in FIG. 10, it is assumed that an image of virtual view of the group of entities is at a distance v from a lens Z1 of the virtual camera, lens Z1 has a focal length f and the virtual camera is along the connection line d1-b1, away from the center of the group, i.e., center of the virtual circle 830, by a distance u, the distance u may be determined by the equation below. In other words, an object X1 may produce an image Y1 through the lens Z1.

$$\frac{1}{u} + \frac{1}{v} = \frac{1}{f}$$

After the location of virtual camera along the camera line is determined, the virtual camera may take an image of virtual view such as, for example, a perspective view, a 3-D view, or any other forms of images, of the entities in the group. In one embodiment, the image may be a combined image of several images that are stitched together. Embodiments of present invention may then provide rendering the image or combined image as a photo to the entities in the group, meeting the desire, demand, or need of taking photos or pictures that has long been felt, sought after, but yet to be met in the virtual reality world, even though such actions of taking photos or pictures with a physical camera has been taken for granted in a real world.

Moreover, in one embodiment and before taking the image or images, embodiments of present invention may provide checking the progress of the live virtual event and/or facial conditions of each individual entities in the group that are photographed such as, for example, through some facial recognition application program, to decide a desired or preferred moment to take the image or images (step 931). Once the photo is rendered to the entities in the group, embodiments of present invention provide ending the virtual camera operation (step 940) or moving onto other groups of entities that are divided from the cluster of entities to continue preparing and taking photos of these other groups.

The descriptions above have been presented for the purposes of illustration of various embodiments of present invention. The terminology used herein was chosen to best explain the principles of the embodiments, practical application or technical improvement over technologies found in the marketplace, and to enable others of ordinary skill in the art to understand the embodiments disclosed herein. In addition, logic and/or operational flows depicted in the drawings do not require the particular order shown, or sequential order, to achieve desirable results. In addition, other steps may be provided, or steps may be eliminated, from the described logic and/or operational flows, and other components may be added to, or removed from, the described systems.

The disclosed embodiments are not intended to be exhaustive and present invention are not limited to these embodiments. Many modifications, substitutions, changes, and equivalents will now occur to those of ordinary skill in the art. Such changes, modification, and/or alternative embodiments may be made without departing from the spirit of present invention and are hereby all contemplated and considered within the scope of present invention. It is, therefore, to be understood that the appended claims are intended to cover all such modifications and changes as fall within the spirit of the invention.

What is claimed is:

1. A method of taking photo in a virtual reality environment, the method comprising:
defining a group that includes multiple entities;
detecting multiple directions that the multiple entities are facing based upon orientations of the multiple entities;
identifying multiple extension lines that start from the multiple entities in the group and extend in the multiple directions;
identifying one or more intersections associated with the multiple directions;
identifying one or more connection lines that connect a center of the group to the one or more intersections;
defining a camera line based on the one or more connection lines;
determining a camera location along the camera line;
taking an image of virtual view of the multiple entities by a virtual camera; and
meeting the need of taking photo by the multiple entities by providing the image as a photo to the multiple entities in the group.

2. The method of claim 1, wherein defining the group comprises identifying the multiple entities from a cluster of entities based on a size of the group and distances among the entities in the cluster.

3. The method of claim 1, wherein identifying the one or more intersections comprises identifying the one or more intersections made by the multiple extension lines.

4. The method of claim 1, wherein identifying the one or more connection lines further comprises identifying the center of the group as a center of a circle that circles the group, wherein at least three entities in the group are along a perimeter of the circle.

5. The method of claim 1, wherein defining the camera line comprises:
if there is only one connection line, defining the camera line as along the connection line; or
if there are two connection lines, defining the camera line as along a line that bisects an ordinary angle formed by the two connection lines; or
if there are more than two connection lines, defining the camera line as along a line that bisects an ordinary angle formed by two connection lines that pass through first two intersections made by majority of the multiple extension lines.

6. The method of claim 1, wherein defining the camera line comprises:
if there is only one connection line, defining the camera line as along the connection line; or
if there are two connection lines, defining the camera line as along a line that bisects an ordinary angle formed by the two connection lines; or
if there are more than two connection lines and there is a reflex angle formed by two adjacent connection lines, defining the camera line as along a line that bisects an explementary angle of the reflex angle formed by the two adjacent connection lines.

7. The method of claim 6, wherein defining the camera line further comprises, if there are more than two connection lines and there is no reflex angle between any two adjacent connection lines, identifying a base connection line that passes through an intersection made by majority of the multiple extension lines; identifying a removable connection line that forms a largest ordinary angle with the base connection line; and removing the removable connection line.

8. The method of claim 1, wherein determining the camera location along the camera line comprises:
deciding a focal length f of the virtual camera;
deciding a distance v of the image of virtual view from the virtual camera; and
determining the camera position along the camera line at a location u measured from the center of the group by an equation of
$$\frac{1}{u} + \frac{1}{v} = \frac{1}{f} .$$

9. A non-transitory storage medium thereupon stored a set of computer-readable instructions that, when being executed by a computer, cause the computer to perform:
defining a group that includes multiple entities;
detecting multiple directions that the multiple entities are facing based upon orientations of the multiple entities;
identifying multiple extension lines that start from the multiple entities in the group and extend in the multiple directions;
identifying one or more intersections associated with the multiple directions;
identifying one or more connection lines that connect a center of the group to the one or more intersections;
defining a camera line based on the one or more connection lines;
determining a camera location along the camera line;
taking an image of virtual view of the multiple entities by a virtual camera; and
meeting the desire of taking photo by the multiple entities by providing the image as a photo to the multiple entities in the group.

10. The non-transitory storage medium of claim 9, wherein defining the group comprises identifying the multiple entities from a cluster of entities based on a size of the group and distances among the entities in the cluster.

11. The non-transitory storage medium of claim 9, wherein identifying the one or more intersections comprises identifying the one or more intersections made by the multiple extension lines.

12. The non-transitory storage medium of claim 9, wherein identifying the one or more connection lines further comprises identifying the center of the group as a center of a circle that circles the group, wherein at least three entities in the group are along a perimeter of the circle.

13. The non-transitory storage medium of claim 9, wherein defining the camera line comprises:
if there is only one connection line, defining the camera line as along the connection line; or
if there are two connection lines, defining the camera line as along a line that bisects an ordinary angle formed by the two connection lines; or
if there are more than two connection lines, defining the camera line as along a line that bisects an ordinary angle formed by two connection lines that pass through first two intersections made by majority of the multiple extension lines.

14. The non-transitory storage medium of claim 9, wherein defining the camera line comprises:
if there is only one connection line, defining the camera line as along the connection line; or
if there are two connection lines, defining the camera line as along a line that bisects an ordinary angle formed by the two connection lines; or
if there are more than two connection lines and there is a reflex angle formed by two adjacent connection lines, defining the camera line as along a line that bisects an explementary angle of the reflex angle formed by the two adjacent connection lines.

15. The non-transitory storage medium of claim 14, wherein defining the camera line further comprises, if there are more than two connection lines and there is no reflex angle between any two adjacent connection lines, identifying a base connection line that passes through an intersection made by majority of the multiple extension lines; identifying a removable connection line that forms a largest ordinary angle with the base connection line; and removing the removable connection line.

16. A computing environment comprising:
a processor set; a communication fabric; at least one volatile memory; a persistent storage; and a set of peripheral devices,
wherein the persistent storage further includes an operating system and stores thereupon a metaverse application program, the metaverse application program, when being executed by the computing environment, causes the computing environment to perform:
defining a group that includes multiple entities;
detecting multiple directions that the multiple entities are facing based upon orientations of the multiple entities;
identifying multiple extension lines that start from the multiple entities in the group and extend in the multiple directions;
identifying one or more intersections associated with the multiple directions;
identifying one or more connection lines that connect a center of the group to the one or more intersections;
defining a camera line based on the one or more connection lines;
determining a camera location along the camera line;
taking an image of virtual view of the multiple entities by a virtual camera; and
meeting the desire of taking photo by the multiple entities by providing the image as a photo to the multiple entities in the group.

17. The computing environment of claim 16, wherein identifying the one or more intersections comprises identifying the one or more intersections made by the multiple extension lines.

18. The computing environment of claim 16, wherein identifying the one or more connection lines further comprises identifying the center of the group as a center of a circle that circles the group, wherein at least three entities in the group are along a perimeter of the circle.

19. The computing environment of claim 16, wherein defining the camera line comprises:
if there is only one connection line, defining the camera line as along the connection line; or
if there are two connection lines, defining the camera line as along a line that bisects an ordinary angle formed by the two connection lines; or
if there are more than two connection lines, defining the camera line as along a line that bisects an ordinary angle formed by two connection lines that pass through first two intersections made by majority of the multiple extension lines.

20. The computing environment of claim 16, wherein defining the camera line comprises:
if there is only one connection line, defining the camera line as along the connection line; or
if there are two connection lines, defining the camera line as along a line that bisects an ordinary angle formed by the two connection lines; or
if there are more than two connection lines and there is a reflex angle formed by two adjacent connection lines, defining the camera line as along a line that bisects an explementary angle of the reflex angle formed by the two adjacent connection lines.
